(19) United States
(12) Patent Application Publication
(10) Pub. No.: US 2016/0265949 A1
(43) Pub. Date: Sep. 15, 2016

(54) Flame retardant treatment monitoring system and method

(71) Applicant: Jason D. Rotondo, Braintree, MA (US)

(72) Inventor: Jason D. Rotondo, Braintree, MA (US)

(21) Appl. No.: 15/016,115

(22) Filed: Feb. 4, 2016

Related U.S. Application Data
(60) Provisional application No. 62/112,122, filed on Feb. 4, 2015.

(51) Int. Cl. G01D 7/00; G01N 21/78; G08B 21/18; G01N 31/22; G06K 7/14; G06K 7/10

(52) U.S. Cl. CPC G01D 7/005; G06K 7/1413; G06K 7/1417; G06K 7/10366; G08B 21/18; G01N 31/22; G01N 21/78

(57) ABSTRACT

Methods and systems for flame retardant and/or fireproofing treatment monitoring. Methods and systems allow interested parties (e.g., business or home owners, property managers, insurers, and inspection teams) to quickly assess the current status of a flame retardant and/or fireproofing treatment.

### CROSS-REFERENCE TO RELATED APPLICATIONS

This application claims priority to and the benefit of U.S. Provisional Patent Application No. 62/112,122, filed on Feb. 4, 2015, which is hereby incorporated herein by reference in its entirety.

### TECHNICAL FIELD

This invention generally relates to methods and systems for monitoring flame retardant and/or fireproofing treatments.

### BACKGROUND

To preserve public safety, States and localities are tasked with enforcing some version of fire and building codes in all forms of construction, from the design-build phase through the daily operation and management. Furnishings, finishes, partitions, wall/ceiling assemblies, insulation, and lumber must all achieve a code-specified fire resistant rating depending upon building use, design, location, occupancy classification, and other considerations. In order to achieve the required fire rating, industries will often introduce a fire retardant product at some stage between the manufacturing process and final installation. The methods through which these products are introduced vary, depending upon a number of factors including (but not limited to) industry, manufacturer, material, function and use, maintenance protocols, exposure interior conditions and exterior elements. The two main routes of introduction are typically (1) direct integration during the manufacturing process, or (2) topical treatment post-manufacturing.

The fire resistance ratings imparted by these various flame retardant products are, however, not without limitation. Fire rating performance and properties are susceptible to diminishment by a range of issues—external (such as UV light, water, solvents, wear and tear) and intrinsic (such as deterioration over time). Therefore, commercially available flame retardants (integrated and topical) include labelling referring to the impact of maintenance (or lack thereof) on the longevity and effectiveness of the flame retardant qualities.

Part of the enforcement process is initial AHJ (Authority Having Jurisdiction) approval based on documentation and testing, followed by routine inspections. There is currently no easy or reliable way to ensure that: (1) flame retardant products are consistently applied according to manufacturer specifications, (2) approved items are appropriately maintained to retain their original fire rating as was initially accepted, or (3) maintenance procedures or routine use do not diminish the effectiveness of the fire resistance properties.

To compound this uncertainty, only 2 US States (CA and NY) require formal certification to apply flame retardant chemicals to be used in public, government, academic, or commercial buildings. Within residential buildings, Building and Fire code requirements are even less stringent and require no routine inspections, while the dangers of fire may be even more prevalent. Very few local Fire codes require any recertification if a topical treatment is cleaned, and no known building or fire codes regulate or verify the maintenance and recertification process. Failure to maintain these treatments is a potential fire hazard, public safety issue, and financial and property liability.

A lack of standardized requisite certification qualifications and consistent quality control poses a significant problem for property managers balancing maintenance with safety requirements, AHJ' s confidently inspecting premises within their jurisdiction, and insurers assessing liability and potential risk exposure.

Current products and services designed for inspection-tracking focus on the internal needs and processes of fire stations, building departments, and other AHJ's. This, however, overlooks the need for standardizing, tracking, and managing the compliance life-cycle for consumers, business owners, insurers and inspection units.

### SUMMARY

This summary is provided to introduce a selection of concepts in a simplified form that are further described below in the Detailed Description section. This summary is not intended to identify key features or essential features of the claimed subject matter, nor is it intended to be used as an aid in determining the scope of the claimed subject matter.

In one aspect, embodiments of the present invention relate to a system for monitoring flame retardant treatments utilizing at least one marker that changes state in response to an event that would render ineffective a regulated efficacy of a flame retardant treatment.

In some embodiments of the system, the at least one marker includes at least one indicia, and the system further comprises a database having at least one record associated with the at least one indicia of the at least one marker.

In some embodiments of the system, the at least one record includes information related to one or more of application date of the flame retardant treatment, physical location of the marker, installation location of the marker, contact name, business name, flame retardant product information, flame retardant batch information, certificate number, flame retardant installer, applicator name, applicator company, signatures, photographs, marker history, images, expiration dates, and renewal dates.

In some embodiments of the system, the indicia enables automated data entry or data retrieval, and is implemented as one or more of a one-dimensional bar code, a two-dimensional bar code, and an RFID transmitter.

In some embodiments of the system, the marker includes a reactive material.

In some embodiments of the system, the marker changes color when the reactive material is exposed to at least one specified chemical. In some embodiments of the system, the marker presents a written message when the reactive material is exposed to at least one specified chemical.

In some embodiments of the system, the marker includes a unique alpha-numeric identification.

In some embodiments of the system, further comprising an alert device for issuing an alert regarding the regulated efficacy of the flame retardant treatment.

In some embodiments of the system, the alert is one or more of an SMS, text, and an email message.

In another aspect, embodiments of the invention relate to a method of monitoring at least one flame retardant treatment, the method comprising: applying a flame retardant treatment to a target; applying at least one marker to the target that includes at least one indicia, wherein the at least one marker changes state in response to an event that would render ineffective a regulated efficacy of the flame retardant treatment; creating at least one record in a database, wherein the at least one record is associated with the at least one indicia; and issuing an alert regarding the at least one flame retardant's regulated efficacy.

In some embodiments of the method, the at least one record includes information related to one or more of application date of the flame retardant treatment, physical location of the marker, installation location of the marker, contact name, business name, flame retardant product information, flame retardant batch information, certificate number, flame retardant installer, applicator name, applicator company, signatures, photographs, marker history, images, expiration dates, and renewal dates.

In some embodiments of the method, the indicia enables automated data entry or data retrieval, and is implemented as one or more of a one-dimensional bar code, a two-dimensional bar code, and an RFID transmitter.

In some embodiments of the method, the marker includes a reactive material. In some embodiments of the method, the marker changes color when the reactive material is exposed to at least one specified chemical.

In some embodiments of the method, the marker presents a written message when the reactive material is exposed to at least one specified chemical.

In some embodiments of the method, the marker includes a unique alpha-numeric identification.

In some embodiments of the method, the alert is one or more of an SMS, text, and an email message.

In yet another aspect, embodiments of the invention relate to a system for monitoring flame retardant treatments, the system comprising: at least one marker that changes state in response to an event that would render ineffective a regulated efficacy of a flame retardant treatment; at least one indicia associated with the at least one marker; a database having at least one record associated with the at least one indicia; and an alert device in operable communication with the database for issuing an alert regarding the regulated efficacy of the flame retardant.

### BRIEF DESCRIPTION OF DRAWINGS

Non-limiting and non-exhaustive embodiments of the invention are described with reference to the following figures, wherein like reference numerals refer to like parts throughout the various views unless otherwise specified.

FIG. 1 schematically illustrates a flame retardant and/or fireproofing treatment monitoring system in accordance with one embodiment of the invention;

FIG. 2 generally illustrates an exemplary valid label in accordance with one embodiment of the present invention;

FIG. 3 generally illustrates an exemplary invalid label in accordance with one embodiment of the present invention;

FIG. 4 generally illustrates an exemplary invalid label in accordance with another embodiment of the present invention;

FIG. 5 depicts a flow chart illustrating a flame retardant and/or fireproofing monitoring, inspection and recertification process in accordance with one embodiment of the present invention;

FIG. 6 depicts a flow chart of a method for information logging and labeling in accordance with one embodiment of the present invention;

FIG. 7 depicts a flow chart of a method for automated compliance tracking notifications in accordance with one embodiment of the present invention;

FIG. 8 depicts a flow chart of a failed visual inspection process of a label in accordance with one embodiment of the present invention; and

FIG. 9 depicts a flow chart of a successful visual inspection of a label and validity confirmation through the remote reporting system in accordance with one embodiment of the invention.

### DETAILED DESCRIPTION

Various embodiments are described more fully below with reference to the accompanying drawings, which form a part hereof, and which show specific exemplary embodiments. However, the concepts of the present disclosure may be implemented in many different forms and should not be construed as limited to the embodiments set forth herein; rather, these embodiments are provided as part of a thorough and complete disclosure, to fully convey the scope of the concepts, techniques and implementations of the present disclosure to those skilled in the art. Embodiments may be practiced as methods, systems or devices. Accordingly, embodiments may take the form of a hardware implementation, an entirely software implementation or an implementation combining software and hardware aspects. The following detailed description is, therefore, not to be taken in a limiting sense.

Reference in the specification to “one embodiment” or to “an embodiment” means that a particular feature, structure, or characteristic described in connection with the embodiments is included in at least one example implementation or technique in accordance with the present disclosure. The appearances of the phrase “in one embodiment” in various places in the specification are not necessarily all referring to the same embodiment.

Some portions of the description that follow are presented in terms of symbolic representations of operations on non-transient signals stored within a computer memory. These descriptions and representations are used by those skilled in the data processing arts to most effectively convey the substance of their work to others skilled in the art. Such operations typically require physical manipulations of physical quantities. Usually, though not necessarily, these quantities take the form of electrical, magnetic or optical signals capable of being stored, transferred, combined, compared and otherwise manipulated. It is convenient at times, principally for reasons of common usage, to refer to these signals as bits, values, elements, symbols, characters, terms, numbers, or the like. Furthermore, it is also convenient at times, to refer to certain arrangements of steps requiring physical manipulations of physical quantities as modules or code devices, without loss of generality.

However, all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices. Portions of the present disclosure include processes and instructions that may be embodied in software, firmware or hardware, and when embodied in software, may be downloaded to reside on and be operated from different platforms used by a variety of operating systems.

The present disclosure also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each may be coupled to a computer system bus. Furthermore, the computers referred to in the specification may include a single processor or may be architectures employing multiple processor designs for increased computing capability.

The processes and displays presented herein are not inherently related to any particular computer or other apparatus. Various general-purpose systems may also be used with programs in accordance with the teachings herein, or it may prove convenient to construct more specialized apparatus to perform one or more method steps. The structure for a variety of these systems is discussed in the description below. In addition, any particular programming language that is sufficient for achieving the techniques and implementations of the present disclosure may be used. A variety of programming languages may be used to implement the present disclosure as discussed herein.

In addition, the language used in the specification has been principally selected for readability and instructional purposes and may not have been selected to delineate or circumscribe the disclosed subject matter. Accordingly, the present disclosure is intended to be illustrative, and not limiting, of the scope of the concepts discussed herein.

Embodiments of the present invention provide a system which will allow interested parties (e.g., business or home owners, property managers, insurers, and inspection teams) to quickly assess the current status of a flame retardant treatment.

In the context of the present application, the terms “flame retardant,” “fire retardant,” or “treatment” may refer to any type of flame retardant and/or fireproofing techniques or products. These terms are also meant to encompass spray-applied fire resistant and/or fireproofing materials and/or methods.

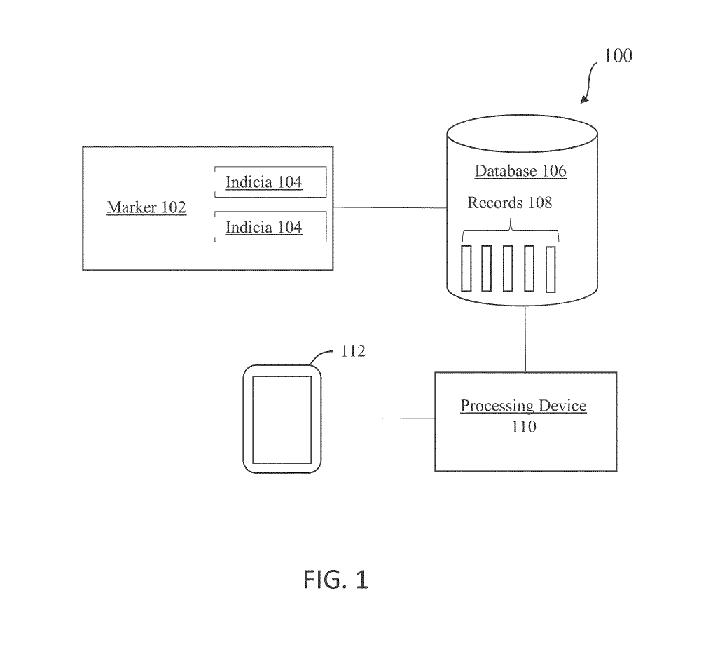

FIG. 1 generally illustrates components of the fire retardant monitoring system 100 in accordance with one embodiment of the invention. The system 100 may include a marker 102 with at least one indicia 104, a database 106 containing a plurality of records 108 regarding a plurality of markers 102. The system 100 may further include a processing device 110, and an input/output (I/O) device 112 that may at least serve as an alert device.

In use, an operator may apply a flame retardant and fireproofing treatment to a target. The operator may then place a marker 102 on or near the target to indicate that the target has been treated with flame retardant and fireproofing substance (flame retardant may also be applied directly on a marker 102). The operator may then create or update a record in the database 108 to indicate that this particular target has been treated with flame retardant and fireproofing substance, such as a fire resistant spray. For example, the operator may be carrying an I/O device 112 such as a mobile device (e.g., a mobile telephone), a tablet, a laptop, etc, and may input information to that effect in the record 110.

The processing device 110 may track flame retardant and fireproofing product application dates and may cause an alert to be communicated to an operator via the I/O device 112 when a marker needs re-application of the flame retardant (e.g., due to an expiration or renewal date). This alert may be communicated in a text message, an SMS message, an auditory message, a haptic-based message, an email message, or any combination thereof. As discussed below, an alert may be issued at any time regarding the status of a particular marker 102 or flame retardant and fireproofing treatment.

The marker 102 may present information associated with a flame retardant and fireproofing treatment applied to a target. The marker 102 may include an at least one indicia 104 associated with at least one record 108 in a database 106. The record(s) 108 may contain information about a particular marker 102, such as when the corresponding flame retardant and fireproofing treatment was applied. If the processing device 110 determines that a flame retardant treatment corresponding to a particular marker 102 is compromised, an alert may be communicated to the I/O device 112 so that an inspector or other interested party may perform a certain action(s) such as reapplying a flame retardant, for example.

The marker(s) 102 may be any type of label (i.e., a flame certificate) that can be affixed to or near a target that has been treated with fire retardant. This may allow interested parties (e.g., business or home owners, property managers, insurers, inspection teams, guests, patrons, customers, clients, or the like) to quickly assess the current status of the flame retardant and fireproofing treatment.

According to some embodiments of the present disclosure, when a target is treated with a flame retardant and fireproofing formula, such as a fire-resistant spray, a signed and stamped flame certificate may be issued, and the marker 102 or other label may be applied to the target. For example, the marker 102 or other label may be applied directly to a target (such as a lobby curtain) or to a designated location to signify treatment of a particular location (such as an entrance to a Conference room or an elevator) or compliance of subunits within a particular location (such as an entrance to an apartment building).

The indicia 104 may present information that may be necessary for performing one or more functions; such as onsite review, confirming an application or identity of an applicant (e.g., company name, phone, website login, applicator name, date of application, date of expiration, etc.). Additionally, certain types of indicia 104 may be formatted for automated handling. For example, the indicia 104 may be in the form of a computer-readable medium including bar codes, such as a one-dimensional or two-dimensional (e.g., quick response or “QR”) bar code, an RFID transmitter and/or receiver or any other like device or marking for aiding in electronic information transfer. Additional pertinent information may also be logged electronically at the time of application and certification. The logged information may include, but is not limited to, application date, physical location, installation location, contact name, business name, flame retardant product and/or formulation, flame retardant lot/batch information, flame certificate numbers, applicator company, applicator name, electronic or digital signatures, photographs, images, and expiration and renewal dates.

Any or all of the foregoing data may be stored in any manner and on any computer device or system, including one or more databases 106 or data stores, or maintained on any type or form of tangible or non-tangible computer-readable media. The data may be structured or unstructured, and may reside in a local terminal or server, or a remote terminal or server (e.g., cloud or hosted database), or any combination of these locations. Each scanned code, registration number, and label may be associated with or serve as an index to an individual record within the database.

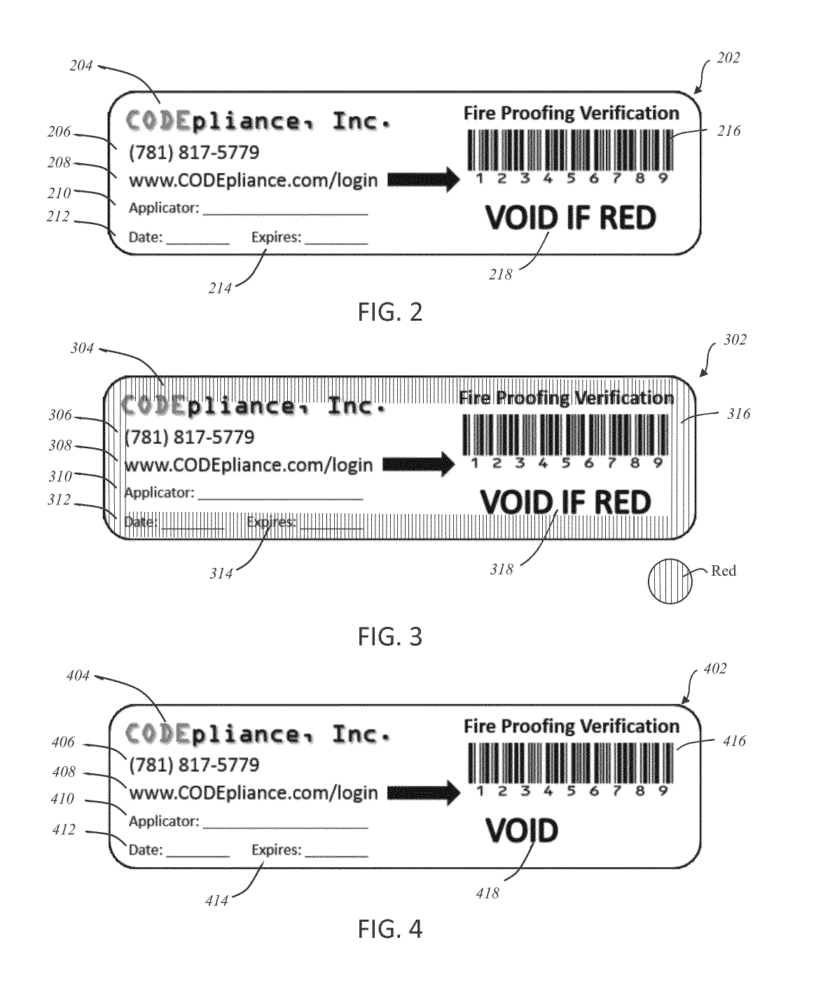

FIG. 2 illustrates an exemplary valid marker 202, which may be applied at the time of applying a flame retardant and fireproofing product in accordance with the method described. As can be seen, this marker 202 includes an applicator company name 204, applicator telephone number 206, applicator URL 208, applicator personnel name 210, date of most recent application 212, expiration date 214, indicia in the form of a one-dimensional bar code 216, and a validity message 218.

The marker 202 is unblemished, neutral white, and all printed information is visible and legible. This implies the label has not been exposed to water or other solvent; therefore, it reflects a valid flame retardant and fireproofing treatment immediately apparent upon simple visual inspection.

FIG. 3 illustrates an exemplary invalid marker 302 in accordance with one embodiment of the invention. This marker 302 may have previously been applied at the time of applying a flame retardant and fireproofing product. Portions 304, 306, 308, 310, 312, 314, and 316 of marker 302 are substantially similar to portions 204, 206, 208, 210, 212, 214 and 216, respectively, of marker 202 of FIG. 2 and are not repeated here.

The marker 302 is blemished and the color of the marker 302 material is changed to red (indicated by vertical lines) in accord with the legend “VOID IF RED”, but the printed information is otherwise visible and legible. This implies the label has been exposed to water or another solvent; therefore, it reflects an invalid flame retardant and fire proofing treatment immediately apparent upon simple visual inspection.

FIG. 4 illustrates an exemplary invalid marker 402 in accordance with one embodiment of the invention. This marker 402 may have previously been applied at the time of applying a flame retardant and fireproofing product. Portions 404, 406, 408, 410, 412, 414, and 416 of marker 402 are substantially similar to portions 204, 206, 208, 210, 212, 214 and 216, respectively, of marker 202 of FIG. 2 and are not repeated here.

The marker 402 is unblemished and the color of the marker 402 material is unchanged from neutral white, but not all printed information is visible and legible (and the word “VOID” is clearly displayed). This implies the marker 402 has been exposed to water or other solvent; therefore, it reflects an invalid flame retardant and fireproofing treatment immediately apparent upon simple visual inspection.

In the embodiment illustrated in FIG. 4, the written message 418 may be changed to indicate an invalid flame retardant and fireproofing product in a variety of ways. For example, the marker 402 may initially present no message (e.g., just a blank space). Upon exposure to water or another solvent, the word “VOID” may then appear. Or, the written message 418 may initially be “NOT VOID.” Upon exposure to water or another solvent, the word “NOT” may disappear and thereby leave only the word “VOID.” This may be accomplished by using different types of reactive materials on different portions of the marker 402.

As can be seen in FIGS. 2-4 and in the above discussion, various embodiments of the marker in accord with the present invention provide insight into the effectiveness, validity, and status of fire retardant and fireproofing qualities through one or more methods:

(1) Visual inspection: The marker itself may be made of a reactive material—one that changes color in the presence of water or another specified chemical (e.g., detergent, bleach, peroxides, solvents). In the presence of the specified chemical the marker may change color—for instance, white to red in the presence of water. Also, particular information may be printed using solvent sensitive (reactive) ink. In the presence of the specified chemical the ink may change color, appear, or disappear in natural light—for instance, the word “VOID” may become visible to the naked eye when exposed to dry-cleaning solvents. When these two measures are combined, a marker can quickly alert an inspecting person or other interested party with a cursory glance whether a target was exposed to some factor which would compromise the flame-retardant and fireproofing treatment.

(2) Scanning inspection: QR-codes, barcodes, RFID and the like may be included on a marker to allow automated data entry and data retrieval. Through the use of a mobile application or other appropriate scanning software, individuals with appropriate access privileges can read information encoded on the marker as well as retrieving additional information associated with the marker stored in a remote database, including but not limited to the location's/product's life-cycle—initial application, routine maintenance, and recertification history.

(3) Web-based inspection: Each marker may also contain a unique alpha-numeric identification or registration number. By providing this ID number to a website, individuals with appropriate access privileges may retrieve a variety of information associated with the marker, as discussed above. Depending upon their security privileges, individuals can retrieve and report other information stored in the system such as information relevant to corporations (such as a General Manager ascertaining information about several locations), geographical area (such as a Fire Prevention Officer searching for all soon-to-expire flame certificates in an inspection region), or multi-unit locations (such as a Property Owner determining percent or total count of compliance across all sub-units).

Through these features, or others, one or more interested parties (e.g., (i.e. AHJ inspection teams, insurers, property managers, private residents, or business owners) may retrieve information or data regarding a status of flame retardant and fireproofing treatment, or determine or confirm a status of an application of the flame retardant and fireproofing treatment, including but not limited to whether the flame retardant and fireproofing treatment was applied by a qualified personnel.

As seen in FIGS. 2-4 markers may provide immediate or apparent information regarding a status of a flame retardant and fireproofing treatment, e.g., efficacy and validity. For example, some markers may be configured to change colors or other aspects of their appearance, or to display one or more indicators such as the word “VOID” to indicate diminished flame resistance and are an immediate call to action for reapplication and certification. Upcoming expiration dates trigger the system 100 to send designated individuals automated alerts in the form of emails, SMS/text messages, or other communications to inform recipients of impending renewal deadlines.

In the case of recertification, renewal, or maintenance procedures, markers that reflect invalid information, (e.g., including, but not limited to expired information, diminished efficacy, or conditions that render the flame retardant and fireproofing treatment void) are removed and replaced with markers that may reflect current and active information while referencing any original or legacy information. Implementation of this systematized monitoring and recertification, renewal, and maintenance process ensures consistent compliance and flame resistance properties in a broad range of application areas where there is currently no comparable system available.

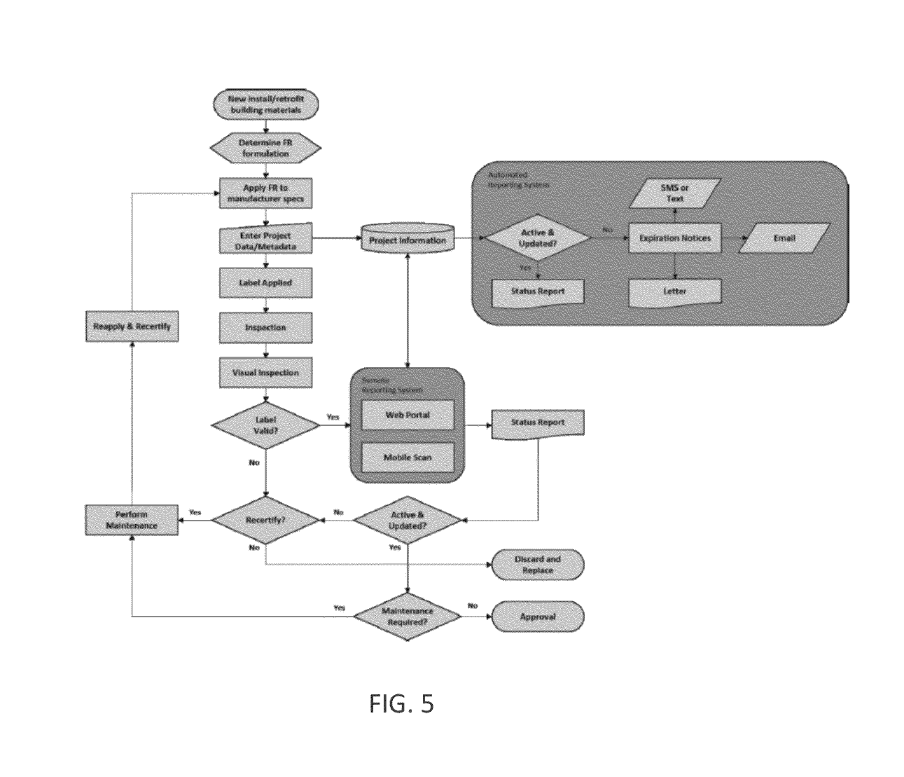

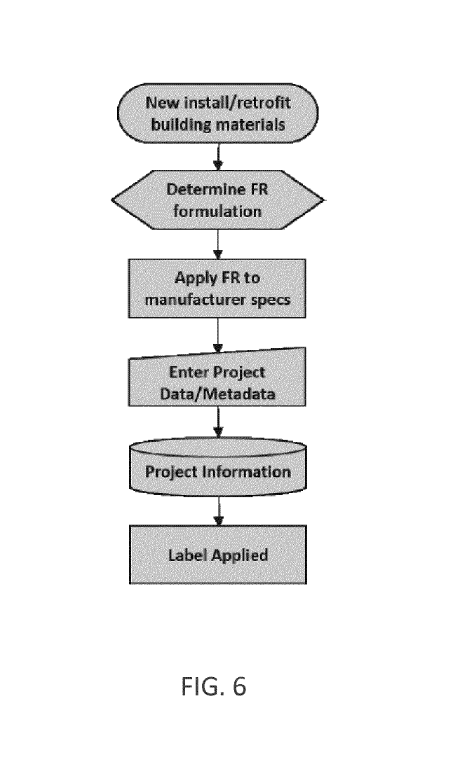

FIG. 5 depicts a flow chart of a complete flame retardant and fireproofing monitoring, inspection and (re)certification process, in accordance with the embodiment. Specific sub-processes shown in FIG. 5 are shown in FIGS. 6-9.

FIG. 6 depicts a flow chart illustrating information logging and labeling. All information as described in the Method Description is entered into a record within a central database. The information and logging process includes installing retrofitting building materials (e.g., potential flame retardant treatment targets), determining flame retardant and fireproofing formulation, applying the flame retardant and fireproofing to manufacturer specifications, entering project data/metadata, storing project information, and applying a marker. The marker (e.g., label) is generated with unique identifying information that correlates to that specific record 110 in a database 108.

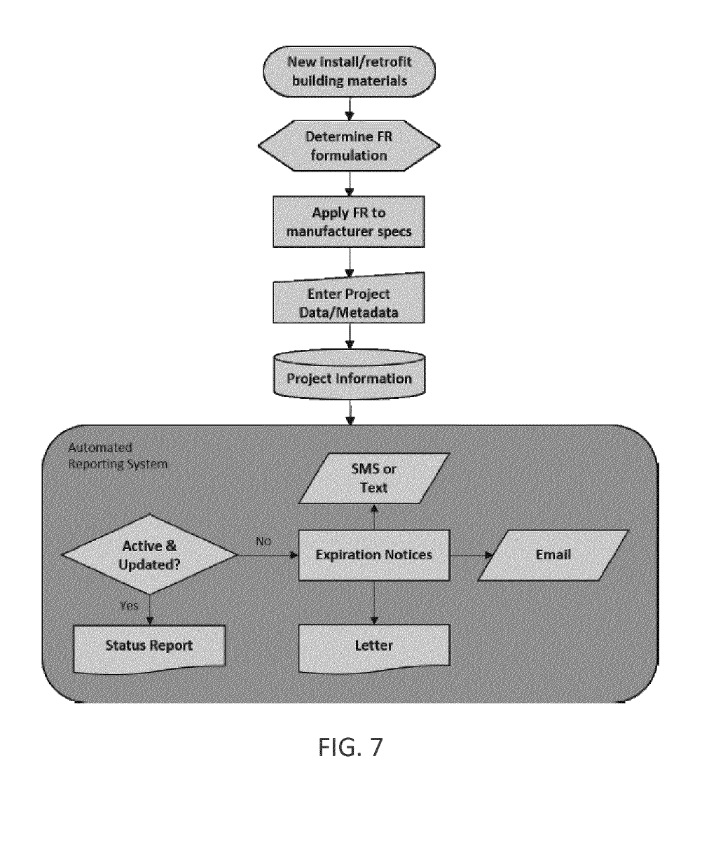

FIG. 7 depicts a flow chart illustrating automated compliance tracking notifications. The system 100 actively monitors various data fields entered at the time of the initial flame retardant treatment. Based on pass/fail criteria set within the system 100, notifications are sent using a variety of vehicles including post, email, text or other method of impending expirations or suggested reapplication. These notifications may be communicated to interested personnel through an I/O (alert) device such as in FIG. 1. Depending upon settings within the monitoring system, notifications are received by private residents, business owners, insurers, authorities having jurisdiction, or other designated individuals.

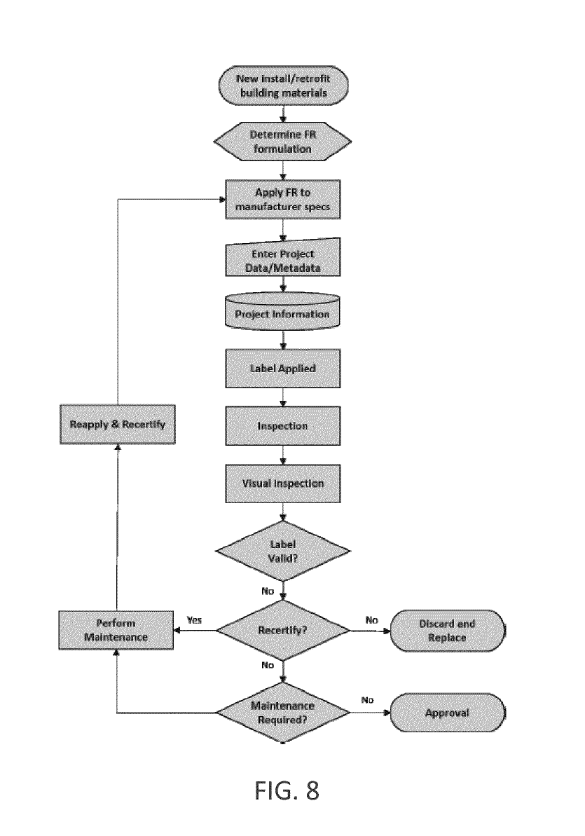

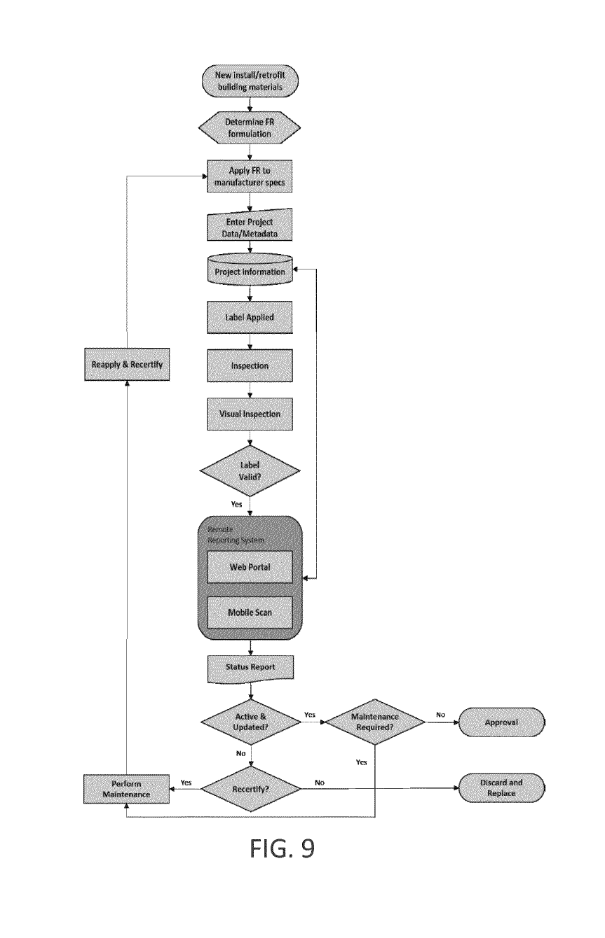

FIGS. 8 and 9 depict successful and failed, respectively, visual inspections of the marker. FIG. 8 involves inspecting a marker (possibly by visual inspection). In this case, the marker (i.e., label) is not valid indicating that the current flame retardant and fireproofing treatment is compromised. The inspector then knows that the current treatment is compromised and items must be either removed, replaced, or recertified to retain the initial flame resistant rating, and the inspector or other interested party may proceed accordingly.

FIG. 9 involves inspecting a marker (possibly by visual inspection). In this case, the marker (i.e., label) is valid indicating the flame retardant treatment has not suffered physical detriment. The inspector may then further confirm validity by accessing information regarding the treatment to ensure no other potential failures exist, such as expiration or suggested reapplication. The term inspector may refer to individuals responsible for the flame retardant and fireproofing treated items, including private residents, business owners, insurers, authorities having jurisdiction, or other designated individuals.

Fire safety and compliance have applications in all public assembly, government, multi-family, commercial, industrial and residential buildings. The present disclosure is a valuable new offering to a wide audience of users including: authorities overseeing inspections of properties within their jurisdiction, insurers in calculating deductibles and premiums, property managers standardizing compliance processes across multiple locations, and business and home owners assessing safety or liability concerns.

The methods, systems, and devices discussed above are examples. Various configurations may omit, substitute, or add various procedures or components as appropriate. For instance, in alternative configurations, the methods may be performed in an order different from that described, and that various steps may be added, omitted, or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Embodiments of the present disclosure, for example, are described above with reference to block diagrams and/or operational illustrations of methods, systems, and computer program products according to embodiments of the present disclosure. The functions/acts noted in the blocks may occur out of the order as shown in any flowchart. For example, two blocks shown in succession may in fact be executed substantially concurrent or the blocks may sometimes be executed in the reverse order, depending upon the functionality/acts involved. Additionally, or alternatively, not all of the blocks shown in any flowchart need to be performed and/or executed. For example, if a given flowchart has five blocks containing functions/acts, it may be the case that only three of the five blocks are performed and/or executed. In this example, any of the three of the five blocks may be performed and/or executed.

A statement that a value exceeds (or is more than) a first threshold value is equivalent to a statement that the value meets or exceeds a second threshold value that is slightly greater than the first threshold value, e.g., the second threshold value being one value higher than the first threshold value in the resolution of a relevant system. A statement that a value is less than (or is within) a first threshold value is equivalent to a statement that the value is less than or equal to a second threshold value that is slightly lower than the first threshold value, e.g., the second threshold value being one value lower than the first threshold value in the resolution of the relevant system.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Having described several example configurations, various modifications, alternative constructions, and equivalents may be used without departing from the spirit of the disclosure. For example, the above elements may be components of a larger system, wherein other rules may take precedence over or otherwise modify the application of various implementations or techniques of the present disclosure. Also, a number of steps may be undertaken before, during, or after the above elements are considered.

Having been provided with the description and illustration of the present application, one skilled in the art may envision variations, modifications, and alternate embodiments falling within the general inventive concept discussed in this application that do not depart from the scope of the following claims.

What is claimed is:

1. A system for monitoring flame retardant treatments utilizing at least one marker that changes state in response to an event that would render ineffective a regulated efficacy of a flame retardant treatment.

2. The system of claim 1 wherein the at least one marker includes at least one indicia, and the system further comprises a database having at least one record associated with the at least one indicia of the at least one marker.

3. The system of claim 2, wherein the at least one record includes information related to one or more of application date of the flame retardant treatment, physical location of the marker, installation location of the marker, contact name, business name, flame retardant product information, flame retardant batch information, certificate number, flame retardant installer, applicator name, applicator company, signatures, photographs, marker history, images, expiration dates, and renewal dates.

4. The system according to claim 2, wherein the indicia enables automated data entry or data retrieval, and is implemented as one or more of a one-dimensional bar code, a two-dimensional bar code, and an RFID transmitter.

5. The system according to claim 1, wherein the marker includes a reactive material.

6. The system according to claim 5, wherein the marker changes color when the reactive material is exposed to at least one specified chemical.

7. The system according to claim 5, wherein the marker presents a written message when the reactive material is exposed to at least one specified chemical.

8. The system according to claim 1, wherein the marker includes a unique alpha-numeric identification.

9. The system according to claim 1, the system further comprising an alert device for issuing an alert regarding the regulated efficacy of the flame retardant treatment.

10. The system according to claim 9, wherein the alert is one or more of an SMS, text, and an email message.

11. A method of monitoring at least one flame retardant treatment, the method comprising:
applying a flame retardant treatment to a target;
applying at least one marker to the target that includes at least one indicia, wherein the at least one marker changes state in response to an event that would render ineffective a regulated efficacy of the flame retardant treatment;
creating at least one record in a database, wherein the at least one record is associated with the at least one indicia; and
issuing an alert regarding the at least one flame retardant's regulated efficacy.

12. The method according to claim 11, wherein the at least one record includes information related to one or more of application date of the flame retardant treatment, physical location of the marker, installation location of the marker, contact name, business name, flame retardant product information, flame retardant batch information, certificate number, flame retardant installer, applicator name, applicator company, signatures, photographs, marker history, images, expiration dates, and renewal dates.

13. The method according to claim 11, wherein the indicia enables automated data entry or data retrieval, and is implemented as one or more of a one-dimensional bar code, a two-dimensional bar code, and an RFID transmitter.

14. The method according to claim 11, wherein the marker includes a reactive material.

15. The method according to claim 14, wherein the marker changes color when the reactive material is exposed to at least one specified chemical.

16. The method according to claim 14, wherein the marker presents a written message when the reactive material is exposed to at least one specified chemical.

17. The method according to claim 11, wherein the marker includes a unique alpha-numeric identification.

18. The method according to claim 11, wherein the alert is one or more of an SMS, text, and an email message.

19. A system for monitoring flame retardant treatments, the system comprising:
at least one marker that changes state in response to an event that would render ineffective a regulated efficacy of a flame retardant treatment;
at least one indicia associated with the at least one marker;
a database having at least one record associated with the at least one indicia; and
an alert device in operable communication with the database for issuing an alert regarding the regulated efficacy of the flame retardant.
